(19) United States
(12) Patent Application Publication
(10) Pub. No.: US 2011/0142058 A1
(43) Pub. Date: Jun. 16, 2011

(54) BRIDGE PROTOCOL FOR FLOW-SPECIFIC MESSAGES

(75) Inventor: Stuart Wagner, Milford, NJ (US)

(73) Assignee: TELCORDIA TECHNOLOGIES, INC., Piscataway, NJ (US)

(21) Appl. No.: 12/634,851

(22) Filed: Dec. 10, 2009

(51) Int. Cl. H04L 12/56

(52) U.S. Cl. 370/401

(57) ABSTRACT

A bridge protocol for controlled information transfer between encrypted and unencrypted networks—and vice versa—by utilizing successive packets of a flow wherein messages are spread across multiple packets and may therefore collectively convey far greater information than is possible in individual per-packet DiffServ Code Points (DSCPs), as practiced in the current art. In a first preferred embodiment the bridge protocol utilizes IPv6 DSCPs in successive packets to provide messages having a length of up to 6n bits in length where n is the number of DSCPs comprising the IPv6 bridge protocol message. In an alternative embodiment, the bridge protocol utilizes DSCPs in successive packets of an IPv4 flow to provide messages having a length of up to 5n bits in length where n is the number of DSCPs comprising the IPv4 bridge protocol message. It further utilizes the DSCP in the last packet of the IPv4 flow to mark the end of the flow. For security purposes, both embodiments include multiple safeguards to prohibit passage of unauthorized information across encryption boundaries.

### FIELD OF THE INVENTION

This invention relates generally to the field of internetworking and in particular to a bridge protocol for effecting communication between encrypted and unencrypted networks or portions thereof.

### BACKGROUND OF THE INVENTION

Encryption devices and methods are pervasive in military Internet Protocol (IP) networks and also in enterprise IP networks that require secure IP communications and may commonly use—for example—Internet Protocol Security suite (IPsec). Network administrators may deploy such encryption devices at an interface between their local networks (“user enclaves”) and the public Internet for the purpose of protecting traffic from spoofing and eavesdropping. Examples of such encryption devices include commercial firewalls and High Assurance IP Encryptors (HAIPEs).

Operationally, these devices effectively separate the path of IP flows into unencrypted (“red”) and encrypted (“black”) portions. The resulting encryption boundary between the unencrypted and encrypted networks is generally known as a “red/black boundary.”

Although the red/black encryption boundary generally provides significant protection for IP traffic, it unfortunately interferes with the coordination of network operations between the red and black portions. For example, it may be difficult for users or hosts in red networks to determine conditions within the black network including, for example, available bandwidth, available routes and congestion levels. Conversely, operators of black networks may find it difficult to tailor their operation to suit user application requirements because the encryption boundary hides detailed user and application information from black network elements.

Prior art approaches to these problems have met with limited success. For example, S. Kent and K. Seo in an article entitled “Security Architecture for the Internet Protocol,” published as RFC 4301 in December 2005, describes a method which bypasses the IP header DiffServ Code Point (DSCP) across the encryption boundary (i.e., the method does not modify the DSCP as the packet passes through the encryption boundary). Since the DSCP is only six-bits in length, the amount of information that may be conveyed across the network boundary via this method is quite limited. Another approach which involves the bypass of IPv6 hop-by-hop extension headers was described in an article entitled “QoS Signaling for IP QoS Support”, published as TIA Standard TIA-1039 in May 2006. Unfortunately, as TIA-1039 acknowledges, this latter approach is not valid for IPv4 and is valid in IPV6 networks only when those networks utilize IPSec in a so-called “transport mode” as opposed to the much more common “tunnel mode”. The TIA-1039 solution therefore has very little practical applicability in networks with encryption boundaries.

Consequently, a mechanism for exchanging more-detailed information across red/black boundaries—while preserving security safeguards that such encryption boundaries provide—would represent an advance in the art.

### BRIEF SUMMARY OF THE INVENTION

An advance is made in the art according to an aspect of the present disclosure directed to a bridge protocol for information transfer between encrypted and unencrypted networks—and vice versa—by utilizing successive packets of a flow. Advantageously, messages according to the present disclosure are spread across multiple packets and may therefore convey more-extensive information across encryption boundaries than the current art's use of DSCPs, which the network interprets on an individual, packet-by-packet basis.

In a first preferred embodiment, the bridge protocol utilizes differentiated services code points (DSCPs) within Traffic Class octets contained in successive packets of an IPv6 flow to provide messages having a length of up to 6n bits in length where n is the number of DSCPs comprising the bridge protocol message for the flow.

In an alternative embodiment the bridge protocol utilizes DSCPs within Type of Service (TOS) octets contained in successive packets of an IPv4 flow to provide messages having a length of up to 5n bits in length where n is the number of DSCPs and packets comprising the bridge protocol message for the flow.

### BRIEF DESCRIPTION OF THE DRAWINGS

A more complete understanding of the present disclosure may be realized by reference to the accompanying drawings in which:

FIG. 1 is a schematic diagram of a network depicting the context for the bridge protocol according to an aspect of the present invention;

FIG. 2 is a schematic diagram of an exemplary bridge protocol message operation for IPv6 networks;

FIG. 3 is a schematic diagram of an exemplary bridge protocol message operation for IPv4 networks;

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

By way of some additional background it is noted that Differentiated Services (DiffServ) is a networking model/technique intended to enable scalable service discrimination in the Internet without the need for per-flow state and signaling at every hop. Operationally a DiffServ (DS) field, known as a Type of Service (TOS) Octet in IPv4 or Traffic Class Octet in IPv6, within a packet header can be used to designate/determine the packet's forwarding treatment within the network. A DS field structure is eight bits in length. Six bits of the DS field are used as a codepoint (Differentiated Services Code Point—DSCP) to select the per-hop behavior (PHB) that a packet experiences at each node within the network. The remaining, two-bit portion of the DS field is currently unused (CU) and generally ignored by differentiated services-compliant nodes when determining the per-hop behavior to apply to a received packet. Generally—and as readily understood by those skilled in the art—the DSCP is the same for each packet of a flow of a contemporary implementation. Moreover, existing networks interpret DSCPs on a packet-by-packet basis and do not perform any concatenation or correlation of DSCPs in successive packets of a flow.

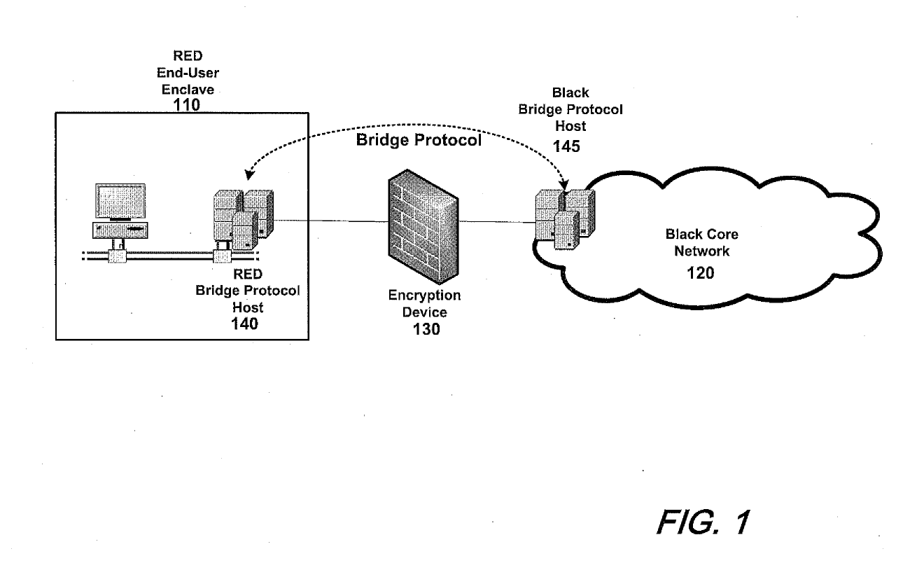

Turning now to FIG. 1, there is shown a schematic diagram of a representative network context in which a bridge protocol according to an aspect of the present disclosure may operate. Shown in FIG. 1 are an unencrypted end-user enclave “red” network 110 and an encrypted core “black” network 120 including a red bridge protocol host (BPH) 140 and a black BPH 145 respectively, which are internetworked via encryption device 130. Encryption devices such as that shown are generally known in the art and may include commercial firewalls, virtual private network (VPN) terminals, and/or high assurance IP encryptors. Those skilled in the art will readily appreciate that while the red and black networks are shown as being directly connected to one another, the connection(s) may include one or more networks as well.

Generally, a method according to the present disclosure will convey a greater amount of flow-related information from red network(s) to black network(s) and black network(s) to red network(s) by utilizing DSCPs in successive packets of a flow. In this mariner, messages may have a length up to 6n bits (for IPv6) or 5n bits (for IPv4), where n is the number of successive packets employed. For our purposes herein, such a method and its underlying data structures are conveniently referred to as a “Bridge Protocol” as shown and designated in FIG. 1. Additionally, it is noted that within the context of an Internet Protocol communications scheme, a flow is a representation of what is commonly understood as an Internet connection. It is typically characterized by five fields namely, a Source IP address; a Destination IP address; a Source port number; a Destination port number; and a Layer 4 protocol, such as TCP, UDP or ICMP.

With continued reference to that FIG. 1, the bridge protocol may conveniently operate between peer bridge protocol hosts (BPHs) 140, 145, which are shown to reside in the network architecture at either side of the encryption boundary formed by encryption device 130. According to an aspect of the present disclosure, the bridge protocol uses the DSCP of successive packets of a flow to convey flow-specific information across the encryption boundary. Advantageously, the bridge protocol does not require any changes to an encryption device or the encryption boundary.

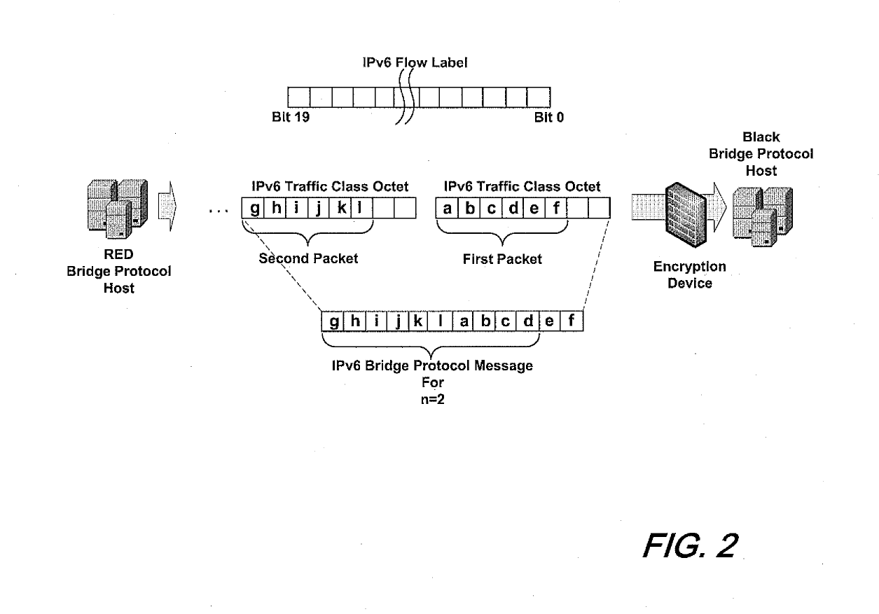

Turning now to FIG. 2 there is shown an exemplary series of packets comprising the bridge protocol operation for an IPv6 network flow wherein n=2. Advantageously—and as may be seen from FIG. 2—with an IPv6 network the standard flow label within the packet header is sufficient to determine the beginning and end of a particular flow. Accordingly, the bridge protocol message length for the case shown wherein n=2 will be 12 bits. More generally, for a Bridge Protocol implementation according to the present disclosure utilizing n IPv6 packets, the overall Bridge Protocol message length will be 6n bits.

Using the packets shown in FIG. 2 as an example, the overall bridge protocol message will be the concatenated DSCPs of the first and second packets. Accordingly, the example bridge protocol message will include the first packet DSCP bits (“a, b, c, d, e, f”) and the second packet DSCP bits (“g, h, i, j, k, l”) such that the overall bridge protocol message for this flow will be “(g, h, i, j, k, l, a, b, c, d, e, f”).

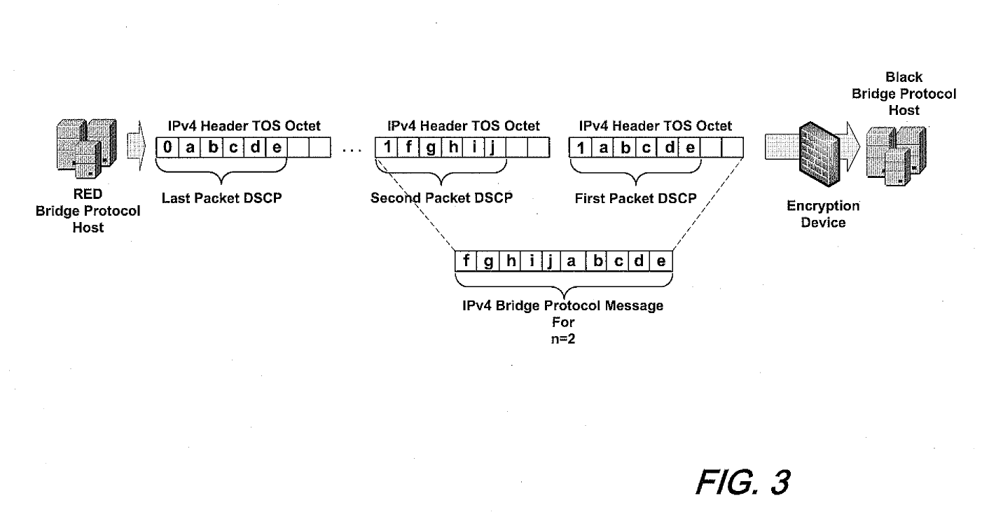

Turning now to FIG. 3, there is shown an exemplary bridge protocol messaging operation for IPv4 according to an aspect of the present disclosure. More particularly, FIG. 3 shows the message formation(s) for red-to-black communication where the number of packets comprising the Bridge Protocol message is two (n=2). Before discussing the particulars of FIG. 3 in detail however, it is noted that while the communication is shown as a red-to-black direction with n=2, those skilled in the art will appreciate that our disclosure is not so limited. More particularly, the communication direction could be from black-to-red as well or combinations thereof, and could utilize n>2.

With continued reference to FIG. 3, an exemplary series of packets comprising a flow is shown. In particular, the exemplary series shows a first packet DSCP, a second packet DSCP and a last packet DSCP along with the bridge protocol message for the exemplary flow. The DSCPs are a part of the standard IPv4 header's TOS Octet.

As can be seen by inspection of FIG. 3, the first packet and the second packet convey the bridge protocol message for the flow. In this example, the protocol data is conveyed in the first packet and is shown as the bits “a, b, c, d, e” while protocol data conveyed in the second packet is shown as the bits “f, g, h, i, j.” Consequently, the overall bridge protocol message for this example is shown to be the bit sequence “f, g, h, j, a, b, c, d, e”, where n—the number of IPv4 DSCPs comprising the message—is equal to 2 (two).

For IPv4, the lack of a flow label in the IP header may interfere with the ability of a black BPH to recognize successive packets within a flow (for purposes of recovering Bridge Protocol messages transmitted by the corresponding red BPH), and to discern the beginning and end of each flow. Recognition of successive packets within a flow will not be a problem if the red and black BPHs are immediately on either side of the encryption boundary, thereby avoiding cross traffic that could otherwise inject packets between successive Bridge Protocol packets. To discern the beginning and end of each flow in IPv4, the Bridge Protocol may use one of the DSCP bits as an indicator. Consequently, of the 12 (twelve) total bits within the DSCP of the first and second packet(s), only 10 (ten) actually convey the bridge protocol message.

Shown in FIG. 3, a “1” bit is in the most significant bit of the DSCP to indicate the start of a flow (or the continuation of an existing flow) while a “0” in the most significant bit location indicates the end of a flow. Accordingly, the last packet shown in FIG. 3 has a “0” in the most significant bit position of the DSCP, and also repeats a portion of the message to assist in identifying the end of the flow

Those skilled in the art will appreciate that the bridge protocol method could—for example—re-send the entire message at the end of the flow (marked with 0's in the most significant bit in each DSCP) if that aided in removing any ambiguity concerning the end of the flow.

At this point those skilled in the art will appreciate that there are a number of possible ways to map information into a chain of packet DSCPs comprising a Bridge Protocol message for a flow. For example—for the exemplary IPv6 flow shown—bit a-f may indicate an application type while bits g-1 may indicate a flow priority, or a bandwidth requirement. For black-to-red communication, the bits may be used to indicate a combination of available (or allocated) bandwidth, or congestion within the black network. Upon receiving the Bridge Protocol message from the black BPH, the red BPH could infer bandwidth and/or congestion values from a configurable library that maps Bridge Protocol message values to specific values of these network parameters. The precision of these values is limited by the number of bits available within the particular protocol.

As may be further appreciated, upon receiving a complete bridge protocol message from its peer across the encryption boundary, a BPH may take whatever action it deems appropriate for flow handling—i.e., termination/rejection of the flow, allocation of bandwidth to the flow, modification of queuing treatment of the flow (for prioritization purposes), or re-routing of the flow.

In principle, the parameter n is bounded only by the number of packets in the flow. A large number n would allow a substantial amount of flow-related data to pass across the encryption boundary. In IP networks, many flows may comprise only a small number of packets. The network operator has two options for handling such flows at BPHs: (1) inject packets into the flow for the sole purpose of carrying Bridge Protocol information between red and black BPHs, if the original flow length is insufficient to convey the desired Bridge Protocol message, or (2) do not apply the Bridge Protocol to these flows.

From a security standpoint, allowing large values of n would, in principle, facilitate possible exploitation of this protocol for purposes of maliciously exfiltrating protected information from red to black, or infiltrating data from black to red. This concern is easily addressed, either within the BPHs or within the encryption device, in three ways. First, one may limit the number of packets in a flow that can have different DSCPs (in other words, by limiting the value of n to a finite number—for example, less than 100). Imposing these limits would severely impair the use of the bridge protocol for malicious purposes. In addition to (or instead of) this limiting approach, both red side and black side BPHs can be implemented to reject flows and bridge protocol messages when non-valid protocol syntaxes (i.e., non-valid message values), such as those that would occur if a malicious user were to transmit non-protocol-related information via the DSCPs. Third, once a BPH has received a Bridge Protocol message from its counterpart BPH on the opposite side of the encryption boundary, it should “zero-out” the message fields, thereby prohibiting further transmission of the embedded information beyond the receiving BPH.

At this point, while we have discussed and described the invention using some specific examples, those skilled in the art will recognize that our teachings are not so limited. Accordingly, the invention should be only limited by the scope of the claims attached hereto.

What is claimed is:

1. A method of conveying a flow-specific message between a first host and a second host comprising the steps of:
embedding at the first host the message within a Differentiated Services Code Point (DSCP) portion of a plurality of successive packets associated with a particular flow; and
extracting at the second host the message by concatenating the DSCP portion of the successive packets associated with the flow.

2. The method of claim 1 wherein said flow is compliant with a standard selected from the group consisting of Internet Protocol Version 6 (IPv6) and Internet Protocol Version 4 (IPv4).

3. The method of claim 1 wherein a portion of said message is indicative of a network characteristic selected from the group consisting of: application type, flow priority, bandwidth requirement(s), available bandwidth(s), allocated bandwidth(s), or congestion.

4. The method of claim 1 wherein said flow is an IPv6 flow and the length of the flow-specific message is 6n bits in length where n is the number of successive DSCPs comprising the flow-specific message.

5. The method of claim 1 wherein said flow is an IPv4 flow, wherein the DSCP portion of the first packet of the plurality of packets includes an indicator that is indicative of the beginning of the flow-specific message and the DSCP portion of the last packet of the plurality of packets includes an indicator that is indicative of the end of the flow-specific message.

6. The method of claim 5 wherein the length of the flow-specific message is 5n bits in length where n is the number of successive DSCPs comprising the flow-specific message.

7. The method of claim 1 wherein said flow-specific message is conveyed from the first host to the second host across an encryption boundary.

8. The method of claim 7 wherein the plurality of packets conveying the flow-specific message and have different DSCPs are limited in number.

9. The method of claim 7 wherein said flow-specific message is rejected when an invalid syntax is determined.

10. The method of claim 7 wherein said DSCPs comprising the flow-specific message are erased at the receiving host.
